(19) United States
(12) Patent Application Publication
(10) Pub. No.: US 2022/0290069 A1
(43) Pub. Date: Sep. 15, 2022

(54) REMEDIATED OILS

(71) Applicant: Treehouse Biosciences, Inc., Longmont, CO (US)

(72) Inventors: Sean COLVIN, Gunbarrel, CO (US); Robert DAVIS, Longmont, CO (US); Jacob BLACK, New Haven, CT (US); Thomas Smeltzer, Longmont, CO (US); John EVANYO, Longmong, CO (US)

(21) Appl. No.: 17/637,319

(22) PCT Filed: Aug. 20, 2020
(86) PCT No.: PCT/US2020/047272

§ 371 Date: Feb. 22, 2022

Related U.S. Application Data
(60) Provisional application No. 62/889,448, filed on Aug. 20, 2019.

(51) Int. Cl. C11B 1/10; C11B 3/00; C11B 3/12

(52) U.S. Cl. CPC C11B 1/10; C11B 3/008; C11B 3/12

(57) ABSTRACT

Remediating hemp oil includes controlling heat and oxygenation levels to reduce the relative weight percentage of THC while mitigating the conversion of other cannabinoids to other compounds. The method may include bubbling air, oxygen, or another oxygen-containing gas into a reactor while maintaining the temperature of the hemp oil.

### CROSS REFERENCE TO RELATED APPLICATIONS

This application is being filed on 20 Aug. 2020, as a PCT International patent application, and claims priority to U.S. Provisional Application No. 62/889,448, filed Aug. 20, 2019, and entitled “REMEDIATED OILS,” which application is incorporated herein by reference in its entirety.

### BACKGROUND

Cannabis plant material contains a variety of potentially valuable compounds. For example tetrahydrocannabinol (THC), cannabidiol (CBD), cannabichromene (CBC), cannabigerol (CBG), cannabinol (CBN), and other compounds are present in varying amounts in cannabis and hemp plant material. For some applications, combining multiple cannabinoid compounds is beneficial.

Various methods of cannabinoid extraction and isolation have been developed. For example, raw cannabis oil containing the aforementioned cannabinoids and other compounds may be extracted from the cannabis flower/plant using techniques such as CO₂ extraction or liquid-solid solvent extraction.

While extraction of the components of cannabis oil enables separation of one or more cannabinoids from other cannabinoids and/or plant material, the remaining components of the cannabis oil are often undesirable due to the chemical composition of those remaining components. In particular, THC may be concentrated in the residue of an extraction process such that it is present in a higher concentration than is found in the starting cannabis oil. The high concentration of THC may pose a problem; it may be undesirable to have oil that has over 0.3% THC where it is unlawful to sell or distribute oils having such a high concentration of THC. Further, THC may be undesirable because of its psychoactive effects. The presence of other cannabinoids in the oil may be desirable, however. Thus, it remains desirous to reduce the concentration and/or presence of THC in various oils, including hemp oil, in a time and efficient manner with minimal influence on the other cannabinoids in the oil.

It is with respect to these and other considerations that the technology is disclosed. Although relatively specific problems have been discussed, it should be understood that the examples presented should not be limited to solving the specific problems identified herein.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

One aspect of the technology is directed to methods for producing remediated oil (i.e., an oil in which the relative concentration of tetrahydrocannabinol has been reduced). These methods include providing a starting material, adding a solvent to the starting material, evaporating the solvent in a vacuum to produce a raw oil, decarboxylating the raw oil to produce a decarboxylated oil, performing a first pass distillation on the decarboxylated oil by heating the decarboxylated oil to produce a first pass distillate and a first pass residue, performing a second pass distillation on the first pass residue by heating the first pass residue to produce a second pass distillate, precipitating the second pass distillate to produce a precipitate and a filtrate, evaporating solvent from the filtrate to produce a filtrate oil, heating the filtrate oil, and remediating the heated filtrate oil to produce a remediated oil.

One aspect of the technology is directed to a method for producing remediated hemp oil. This method includes providing an oil that contains detectable levels of tetrahydrocannabinol, heating the filtrate oil, performing chromatography on the solution, identifying at least one fraction from the chromatography that contains tetrahydrocannabinol, isolating the at least one fraction to provide a filtrate oil, and remediating the heated filtrate oil to produce a remediated hemp oil.

### BRIEF DESCRIPTION OF THE DRAWINGS

FIG. 1 illustrates a method for producing a filtrate oil.

FIG. 2 illustrates a method for producing a filtrate oil using chromatography.

FIG. 3 illustrates a method for producing remediated oil from a filtrate oil.

FIG. 4 illustrates an example system for producing remediated oil.

### DETAILED DESCRIPTION

The terminology used in the disclosure is for the purposes of describing particular examples only and is not intended to be limiting of the disclosure. As used in the description of the examples of the disclosure and the appended claims, the singular forms “a”, “an”, and “the” are intended to include the plural forms as well, unless the context clearly indicates otherwise. Also, as used here, “and/or” refers to and encompasses any and all possible combinations of one or more of the associated listed items. Furthermore, the term “about,” as used here, when referring to a measurable value such as an amount of a compound, amount, dose, time, temperature, and the like, is meant to encompass variations of 20%, 10%, 5%, 1%, 0.5%, or even 0.1% of the specified amount. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise defined, all terms, including technical and scientific terms used in the description, have the same meaning as commonly understood by one of ordinary skill in the art to which this disclosure belongs.

Aspects of this technology relate to methods for producing remediated oil. As used herein, remediated oil is a cannabinoid containing oil having some amount of CBN that has been converted from THC. In some aspects of the technology, the remediated oil may have a THC level below 0.3% by mass.

The remediated oil may be formed by identifying a starting oil with some detectable amount of THC. This starting oil may then be heated and/or oxygenated using the methods, systems, and devices described herein. The THC, in aspects of the technology, reacts with the oxygen in the presence of heat to form other compounds, including CBN.

One problem that the current technology may be used to solve is driving the reaction of THC to other compounds, such as CBN, without denaturing other cannabinoids that are present in the starting hemp oil. For example, a starting hemp oil may have various concentrations by weight of CBN, CBC, CBG, and/or CBD. Aspects of the technology relate to controlling temperature, pressure, and oxygenation levels to drive the conversion of THC while preserving the relative weight concentrations of the CBN, CBC, CBG, and/or CBD of the starting hemp oil.

Temperature, pressure, and time of remediation may be controlled to drive the concentration of THC in the oil to a certain threshold. Also, the reaction may be terminated before other cannabinoids begin to substantially degrade. For example, an oil may be remediated at an elevated pressure and an elevated temperature compared with atmospheric pressure and room temperature for a limited duration. It was observed that THC tended to degrade at a relatively fast rate, while CBC degraded at a slightly lower rate, followed by other cannabinoids. Thus, as further described herein, temperature, pressure, and treatment time may be tightly controlled to reduce THC to under a threshold (such as 0.3%), while relatively maintaining the other cannabinoids at or near their starting concentration.

### Remediation Procedure

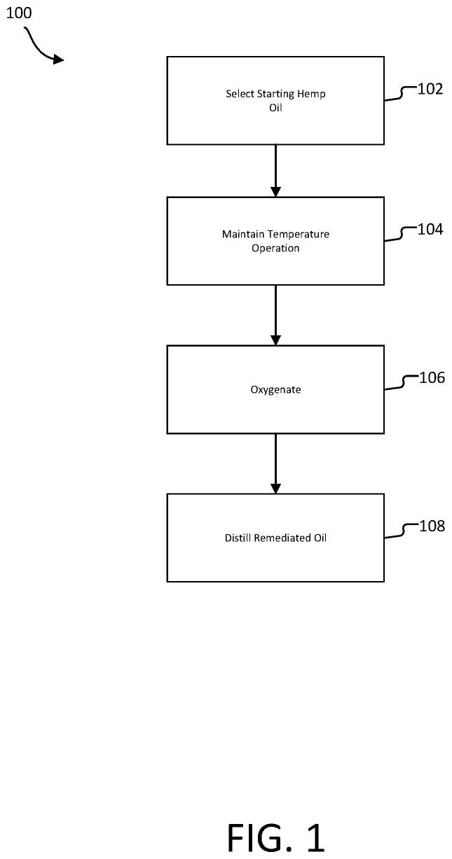

FIG. 1 illustrates a method 100 for producing remediated oil from a hemp oil. Method 100 begins with select starting hemp oil operation 102. In operation 102, a starting hemp oil is selected. The starting hemp oil selected may comprise a detectable amount of THC. For example, the hemp oil may be one or more of the hemp oils described herein or in the incorporated patent applications. In aspects of the technology, the starting hemp oil has a low concentration of CBD by weight (e.g., below 30% by weight). Table A indicates various compositions of hemp oil that may be selected in operation 102.

TABLE A

| % CBD | % THC | % CBG | % CBC | % CBN |
|---|---|---|---|---|
| 31.3% | 7.0% | 3.9% | 8.9% | 0.3% |
| 29.5% | 14.9% | 9.0% | 23.5% | 1.8% |
| 47.2% | 9.1% | 4.8% | 23.5% | 1.8% |
| 4.5% | 2.7% | 20.4% | 51.1% | 0.4% |
| 36.59% | 8.23% | 3.20% | 11.36% | 0.26% |
| 29.50% | 14.90% | 8.97% | 23.50% | 1.80% |
| 47.2% | 9.1% | 2.0% | 4.8% | 1.2% |
| 74.95% | 2.13% | 0.63% | 2.13% | 0.37% |

In an example, the starting hemp oil is a filtrate oil collected in the collect filtrate oil operation 218 described below. In another example, starting hemp oil is the filtrate oil collected from the collect filtrate oil operation 310 described below. Any oil comprising some detectable amount of THC may be used as starting hemp oil. In additional aspects of the technology, the starting hemp oil may not include any THC, but the technology described herein may be used to degrade other cannabinoids, such as CBC, while substantially maintaining the mass percentages of the other cannabinoids.

Method 100 then proceeds to maintain temperature operation 104. In operation 104, the hemp oil is heated (or cooled) to a temperature and then maintained at about that specific temperature (or temperature profile). In an example, the hemp oil is maintained at a temperature of around 80, 90, 100, 110, 120, or 150 degrees Celsius. In other aspects, the temperature is varied by time, i.e., the temperature is held at or around a certain temperature, then at some predetermined time, the temperature is raised/lowered, and then held at or around that other temperature for another amount of time. For example, the reaction may be raised to about 100 degrees Celsius, and then raised to 120° C. after 2 days, then lowered to 90° C. after 1 day. In aspects of the technology, the hemp oil is agitated continuously during operation 304 (e.g., by stirring or mechanical vibration). The hemp oil may be maintained at about 80, 90, 100, 110, 120, or 150 degrees Celsius for 6 hours, 12 hours, 24 hours, 36 hour, 48 hours, 60 hours, 72 hours, 84 hours, 96 hours, 108 hours, 120 hours, 132 hours, 144 hours, 156 hours, 168 hours, 180 hours, 192 hours, 204 hours, 216 hours, 228 hours, 240 hours, 252 hours, 264 hours, 276 hours, and/or 288 hours. During the maintain temperature operation 104, the hemp oil is referred to a heated hemp oil.

Method 100 includes oxygenate operation 106. In operation 106, the hemp oil is oxygenated. This may occur by bubbling a gas (which contains oxygen) through the heated hemp oil. In aspects of the technology, the gas is a blend of oxygen and an inert gas, such as nitrogen, along with other gasses. For example, the gas may be compressed air (e.g., about 78% nitrogen, about 20% oxygen, and the remainder other inert gases, such as argon and carbon dioxide). In aspects of the technology, some or all of bubbling of gas 106 occurs contemporaneously with operation 104. For example, as the heated hemp oil is maintained at a temperature, gas is bubbled regularly or semi-regularly through the heated hemp oil. In an example, the filtrate oil is low concentration CBD oil and a gas (such as air) is bubbled through the filtrate oil until the amount of THC in the filtrate is below the 0.3% by mass. This forms a remediated oil. In aspects of the technology, gas is bubbled through the oil to maintain a pressure in the vessel, such as atmospheric pressure, or gas may be bubbled to maintain a pressure at 75 PSI, 80 PSI, 85 PSI, 90 PSI, 100 PSI, 105 PSI, or 110 PSI. In some instances, a pressure regulator or valve releases pressure to maintain a constant bubbling/introduction of gas. In other examples, gas is bubbled through the oil only when the pressure goes below a certain threshold in order to maintain at or about that threshold (e.g., 95 psi).

Method 100 optionally proceeds to distillation of remediated oil operation 108. In a remediated oil distillation operation 108, the remediated oil may be heated. In examples, the oil is heated to about 170 degrees Celsius under vacuum at <500 mtorr. The remediated oil distillation produces a distillate. In an example the distillate is a clear yellow-orange oil. In an embodiment, the remediated oil may be mixed with a thinning agent prior to distillation. The thinning agent may be canola oil, organic canola oil, vegetable oil, MCT oil, or hempseed oil. In examples, the thinning agent is added at 2.5-7.5% by mass.

In other aspects of the technology, the oxygenation of the starting hemp oil may be accomplished by diffusion at the surface of the hemp oil. That is, the surface of the hemp oil may be exposed to an atmosphere, which atmosphere may be air, oxygen, a nitrogen/oxygen blend, etc. Surface oxygenation may be useful when the surface area to volume is less than 1.26 to 1 for air. When the surface area to volume is less than 1.26 to 1, diffusion of oxygen at the surface area may be sufficient to achieve the desired THC remediation in a timely fashion.

### Examples

In a first example, method 100 was performed on a first hemp oil. The first hemp oil is from a chromatography fraction containing high levels of THC. The hemp oil had a composition shown in Table 1 at time 0. This composition was heated to 150° C. and maintained at around 150° C. (+/−2° C.) for 2 days. Oxygenation of the starting hemp oil was accomplished using surface area diffusion with the atmosphere. The surface area to volume of hemp oil was 5:1. Table 1 further shows the composition of the remediated hemp after one day and two days.

TABLE 1
[150 C. Open to Air D9 Fracs]

| Time | | | | | |
|---|---|---|---|---|---|
| (days) | % CBD | % THC | % CBG | % CBC | % CBN |
| 0 | 29.5% | 14.9% | 9.0% | 23.5% | 1.8% |
| 1 | 28.6% | 5.8% | 9.0% | 13.1% | 9.8% |
| 2 | 22.7% | 1.6% | 6.2% | 6.4% | 16.5% |

In a second example, method 100 was performed on a second hemp oil. The second hemp oil is from a chromatography fraction containing high levels of CBD. Specifically, the second hemp oil had the composition shown in Table 3 at time 0. This composition was heated to 150° C. and maintained at around 150° C. (+/−2° C.) for 2 days. Oxygenation of the starting hemp oil was accomplished using surface area diffusion with the atmosphere. The surface area to volume of hemp oil was 5:1. Table 3 further shows the composition of the remediated hemp oil after one day and two days.

TABLE 2
[150 C. Open to Air Iso Fracs]

| Time | | | | | |
|---|---|---|---|---|---|
| (days) | % CBD | % THC | % CBG | % CBC | % CBN |
| 0 | 47.2% | 9.1% | 4.8% | 23.5% | 1.8% |
| 1 | 41.4% | 1.9% | 2.4% | 13.1% | 9.8% |
| 2 | 20.8% | 3.6% | 0.8% | 0.5% | 17.4% |

In a third example, method 100 was performed on a third hemp oil. The third hemp oil is from a chromatography fraction containing relatively high levels of THC. The third hemp oil had a composition shown in Table 3 at time 0. This composition was heated to 120° C. and maintained at around 120° C. (+/−2° C.) for 7 days. Oxygenation of the starting hemp oil was accomplished using surface area diffusion with the atmosphere. The surface area to volume of hemp oil was 5:1. Table 3 further shows the composition of the remediated hemp oil after one day, three days, four days, five days, six days, and seven days

TABLE 3
[120 C. Open to Air D9 Fracs]

| Time | | | | | |
|---|---|---|---|---|---|
| (days) | % CBD | % THC | % CBG | % CBC | % CBN |
| 0 | 29.50% | 14.90% | 8.97% | 23.50% | 1.80% |
| 3 | 29.76% | 8.46% | 8.85% | 18.67% | 4.61% |
| 4 | 29.17% | 7.02% | 8.71% | 16.49% | 5.90% |
| 5 | 29.0% | 5.4% | 8.6% | 15.5% | 7.2% |
| 6 | 28.5% | 4.0% | 8.4% | 14.8% | 8.4% |
| 7 | 27.70% | 2.94% | 8.06% | 13.52% | 8.96% |

In a fourth example, method 100 was performed on a fourth hemp oil. The fourth hemp oil is from a chromatography fraction containing relatively high levels of CBG and CBC. The fourth hemp oil had a composition shown in Table 4 at time 0. This composition was heated to 120° C. and maintained at around 120° C. (+/−2° C.). for 6 days. Surface area diffusion was employed to oxygenate the starting hemp oil. Table 4 further shows the composition of the remediated hemp oil after one day, two days, three days, and six days.

TABLE 4
[120 C. CB Fracs]

| Time | | | | | |
|---|---|---|---|---|---|
| (days) | % CBD | % THC | % CBG | % CBC | % CBN |
| 0 | 4.5% | 2.7% | 20.4% | 51.1% | 0.4% |
| 1 | 4.0% | 1.7% | 20.0% | 44.4% | 0.9% |
| 2 | 3.6% | 0.9% | 19.0% | 38.9% | 1.5% |
| 3 | 3.6% | 0.8% | 16.8% | 32.6% | 1.9% |
| 6 | 2.90% | 1.22% | 9.28% | 15.79% | 2.81% |

In a fifth example, method 100 was performed on a fifth hemp oil. The fifth hemp oil is from a chromatography fraction containing relatively high levels of THC. The fifth hemp oil had a composition shown in Table 5 at time 0. This composition was heated to 100° C. and maintained at around 100° C. (+/−2° C.) for 7 days. Oxygenation of the starting hemp oil was accomplished using surface area diffusion with the atmosphere. The surface area to volume of hemp oil was 5:1. Table 5 further shows the composition of the remediated hemp oil after three days, four days, five days, six days, and seven days.

TABLE 5
[100 C. Open to Air D9 Fracs]

| Time | | | | | |
|---|---|---|---|---|---|
| (days) | % CBD | % THC | % CBG | % CBC | % CBN |
| 0 | 29.5% | 14.9% | 9.0% | 23.5% | 1.8% |
| 3 | 29.4% | 9.0% | 8.5% | 21.9% | 2.9% |
| 4 | 31.0% | 5.2% | 8.5% | 21.3% | 3.7% |
| 5 | 28.8% | 5.0% | 8.1% | 20.4% | 4.5% |
| 6 | 28.7% | 3.4% | 7.8% | 20.2% | 5.0% |
| 7 | 28.4% | 2.2% | 7.6% | 19.6% | 5.5% |

In a sixth example, method 100 was performed on a sixth hemp oil. The sixth hemp oil is from a chromatography fraction containing relatively high levels of THC. The sixth hemp oil had a composition shown in Table 6 at time 0. This composition was heated to 100° C. and maintained at around 100° C. (+/−2° C.) for 7 days. Oxygenation of the starting hemp oil using surface area diffusion with the oxygen. The surface area to volume of hemp oil was 5:1. Table 6 further shows the composition of the remediated hemp oil after three days, four days, five days, six days, and seven days.

TABLE 6
[100 C. O2 Balloon D9 Fracs]

| Time | | | | | |
|---|---|---|---|---|---|
| (days) | % CBD | % THC | % CBG | % CBC | % CBN |
| 0 | 29.5% | 14.9% | 9.0% | 23.5% | 1.8% |
| 3 | 26.6% | 6.8% | 7.7% | 19.6% | 3.2% |
| 4 | 28.2% | 4.6% | 7.9% | 19.9% | 4.4% |
| 5 | 28.4% | 2.3% | 7.7% | 19.6% | 5.5% |
| 6 | 27.2% | 1.0% | 7.0% | 19.1% | 5.8% |
| 7 | 27.0% | 0.0% | 6.6% | 18.5% | 6.2% |

In a seventh example, method 100 was performed on a seventh hemp oil. The seventh hemp oil is from a chromatography fraction containing relatively high levels of THC. The seventh hemp oil had a composition shown in Table 7 at time 0. This composition was heated to 90° C. and maintained at around 90° C. for 16 days. Compressed air was bubbled at a rate of 2.5 SCFM into 1 Liter of oil for the duration of the example Table 7 further shows the composition of the remediated hemp oil after the days indicated in the time column.

TABLE 7
[90 C. D9 Fracs (Reactor)]

| Time | % CBD | % THC | % CBG | % CBC | % CBN |
|---|---|---|---|---|---|
| 0 | 29.50% | 14.90% | 8.97% | 23.50% | 1.80% |
| 1 | 29.39% | 13.42% | 8.58% | 22.52% | 1.91% |
| 2 | 29.70% | 12.37% | 8.54% | 22.18% | 2.26% |
| 3 | 27.84% | 11.66% | 9.36% | 20.93% | 3.99% |
| 6 | 27.11% | 8.16% | 8.87% | 19.68% | 4.88% |
| 7 | 28.92% | 7.26% | 9.08% | 20.41% | 5.16% |
| 8 | 24.75% | 4.68% | 7.72% | 17.29% | 5.07% |
| 10 | 24.69% | 4.35% | 7.92% | 17.27% | 5.59% |
| 14 | 19.09% | 1.30% | 6.70% | 13.46% | 5.93% |
| 15 | 23.80% | 0.63% | 7.40% | 16.23% | 6.76% |
| 16 | 20.25% | 0.24% | 6.04% | 13.66% | 5.67% |

In an eighth example, method 100 was performed on an eighth hemp oil. The eighth hemp oil is from a chromatography fraction containing relatively high levels of THC. The eighth hemp oil had a composition shown in Table 8 at time 0. This composition was heated to 80° C. and maintained at around 80° C. for 8 days. Oxygenation of the starting hemp oil occurred by using surface area diffusion with the atmosphere. The surface area to volume of hemp oil was 5:1. Table 8 further shows the composition of the remediated hemp oil after the days indicated in the time column.

TABLE 8
[80 C. Open to Air D9 Fracs]

| Time (d) | % CBD | % THC | % CBG | % CBC | % CBN |
|---|---|---|---|---|---|
| 0 | 29.5% | 14.9% | 9.0% | 23.5% | 1.8% |
| 1 | 26.5% | 12.9% | 8.0% | 20.5% | 1.5% |
| 2 | 29.7% | 14.3% | 9.0% | 23.1% | 2.1% |
| 3 | 29.61% | 14.22% | 8.99% | 23.14% | 2.28% |
| 6 | 25.92% | 11.40% | 7.75% | 19.57% | 1.93% |
| 7 | 32.48% | 13.07% | 9.33% | 23.90% | 2.38% |
| 8 | 32.55% | 12.68% | 9.39% | 23.60% | 2.56% |

In a ninth example, method 100 was performed on a ninth hemp oil. The ninth hemp oil is from a chromatography fraction containing relatively high levels of THC. The ninth hemp oil had a composition shown in Table 9 at time 0. This composition was heated to 80° C. and maintained at around 80° C. for 6 days. Oxygenation of the starting hemp oil was accomplished using surface area diffusion with the atmosphere. The surface area to volume of hemp oil was 5:1. Table 9 further shows the composition of the remediated hemp oil after the days indicated in the time column.

TABLE 9
[80 C. Open to Air Iso Fracs]

| Time (d) | % CBD | % THC | % CBG | % CBC | % CBN |
|---|---|---|---|---|---|
| 0 | 47.2% | 9.1% | 2.0% | 4.8% | 1.2% |
| 1 | 49.0% | 11.0% | 2.1% | 4.8% | 1.4% |
| 4 | 41.9% | 8.6% | 1.6% | 3.8% | 1.1% |
| 5 | 53.3% | 9.8% | 1.87% | 4.9% | 1.3% |
| 6 | 51.93% | 9.28% | 1.79% | 4.01% | 1.36% |

In a tenth example, method 100 was performed on a tenth hemp oil. The tenth hemp oil is from a chromatography fraction containing relatively high levels of THC. The tenth hemp oil had a composition shown in Table 10 at time 0. This composition was heated to 80° C. and maintained at around 80° C. (+/−2° C.) for 6 days. Oxygenation of the starting hemp oil was accomplished using surface area diffusion with the atmosphere. The surface area to volume of hemp oil was 5:1. Table 10 further shows the composition of the remediated hemp oil after the days indicated in the time column.

TABLE 10
[80 C. Open to Air CB Fracs]

| Time (d) | % CBD | % THC | % CBG | % CBC | % CBN |
|---|---|---|---|---|---|
| 0 | 4.5% | 2.7% | 20.4% | 51.1% | 0.4% |
| 1 | 4.9% | 2.5% | 19.7% | 49.5% | 0.6% |
| 4 | 4.4% | 2.5% | 20.0% | 50.8% | 0.5% |
| 5 | 4.0% | 1.9% | 20.5% | 50.8% | 0.4% |
| 6 | 4.09% | 1.72% | 18.53% | 46.04% | 0.24% |

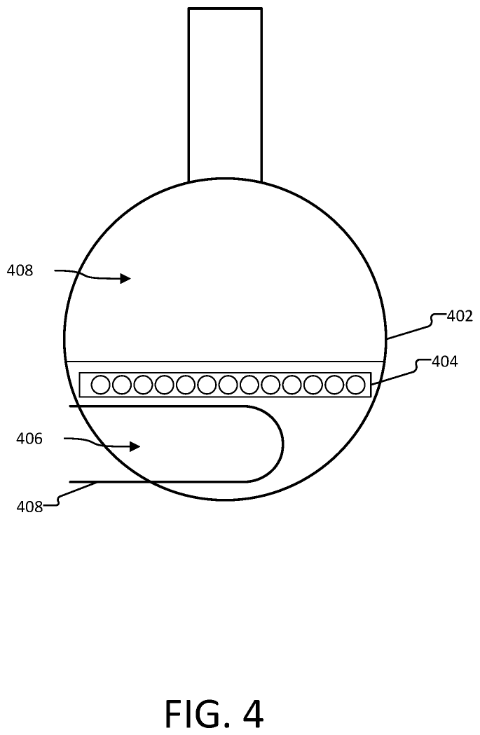

In an eleventh example, method 100 was performed on an eleventh hemp oil. The eleventh hemp oil is from solvent extraction of hemp biomass using method 200 and is the product resulting from operation 208. The oil has the composition shown in Table 11 at time 0. This composition was heated to 95° C. (+/−2° C.) for 11 days. Oxygenation of the starting oil was accomplished with a perforated gas line, such as the one shown in FIG. 4. Table 11 further shows the composition of the remediated hemp oil after the days indicated in the time column.

TABLE 11
[95 C. Crude Oil]

| Time (d) | % CBD | % THC | % CBG | % CBC | % CBN |
|---|---|---|---|---|---|
| 0 | 45.16% | 1.38% | 1.01% | 2.21% | 0.04% |
| 4 | 46.47% | 0.49% | 0.70% | 1.14% | —% |
| 7 | 45.24% | 0.55% | 0.90% | 1.00% | 0.29% |
| 11 | 42.33% | 0.31% | 0.80% | 0.67% | 0.37% |

In a twelfth example, method 100 was performed on a twelfth hemp oil. The twelfth hemp oil is distilled hemp oil produced using method 200 and is the product resulting from operation 212. The oil has the composition shown in Table 12 at time 0. This composition was heated to 95° C. (+/−2° C.) for 13 days. Oxygenation of the starting oil was accomplished with a perforated gas line, such as the one shown in FIG. 4. Table 12 further shows the composition of the remediated hemp oil after the days indicated in the time column.

TABLE 12
[95 C. Distillate Oil]

| Time (d) | % CBD | % THC | % CBG | % CBC | % CBN |
|---|---|---|---|---|---|
| 0 | 68.09% | 2.14% | 0.72% | 2.10% | 0.30% |
| 1 | 74.95% | 2.13% | 0.63% | 2.13% | 0.37% |
| 2 | 74.26% | 1.84% | 0.68% | 2.15% | 0.52% |
| 5 | 71.97% | 0.88% | 0.63% | 2.01% | 0.95% |
| 6 | 63.82% | 0.68% | 0.56% | 1.78% | 0.98% |
| 7 | 64.71% | 0.49% | 0.56% | 1.79% | 1.13% |
| 8 | 62.18% | 0.30% | 0.49% | 1.64% | 1.17% |
| 12 | 61.79% | 0.04% | 0.45% | 1.59% | 1.25% |
| 13 | 62.83% | 0.00% | 0.38% | 1.69% | 1.21% |

In a thirteenth example, method 100 was performed on a thirteenth hemp oil. The thirteenth hemp oil is from extraction of hemp biomass. The oil has the composition shown in Table 13 at time 0. This composition was heated to 95° C. for 11 days. Oxygenation of the starting oil was accomplished with a bubbler (perforated pipe inserted into oil). Table 13 further shows the composition of the remediated hemp oil after the days indicated in the time column.

TABLE 13
[95 C. Organic Crude Oil from CO2]

| Time (d) | % CBD | % THC | % CBG | % CBC | % CBN |
|---|---|---|---|---|---|
| 0 | 57.41% | 3.48% | 2.78% | 8.97% | 0.18% |
| 4 | 57.45% | 1.77% | 2.22% | 8.41% | 0.47% |
| 7 | 56.63% | 1.17% | 2.33% | 8.74% | 1.07% |
| 11 | 54.80% | —% | 2.25% | 8.21% | 1.41% |

In a fourteenth example, method 100 was performed on a fourteenth hemp oil. The fourteenth hemp oil is distilled hemp oil produced using method 200 and is the product resulting from operation 212. The oil has the composition shown in Table 14 at time 0. This composition was heated to 95° C. (+/−2° C.) for 11 days. Oxygenation of the starting oil was accomplished with a perforated gas line, such as the one shown in FIG. 4. Table 14 further shows the composition of the remediated hemp oil after the days indicated in the time column.

TABLE 14
[95 C. CBG-rich Oil]

| Time (d) | % CBD | % THC | % CBG | % CBC | % CBN |
|---|---|---|---|---|---|
| 0 | 8.50% | 0.90% | 73% | 2.30% | 0.00% |
| 1 | 8.38% | 1.01% | 72.78% | 2.53% | 0.07% |
| 2 | 8.36% | 0.85% | 71.53% | 2.49% | 0.10% |
| 5 | 8.07% | 0.40% | 67.39% | 2.70% | 0.23% |
| 6 | 8.12% | 0.40% | 67.34% | 3.00% | 0.22% |
| 7 | 7.32% | 0.21% | 62.27% | 2.70% | 0.21% |
| 8 | 7.15% | 0.14% | 59.84% | 2.80% | 0.23% |
| 9 | 7.75% | 0.11% | 64.70% | 3.25% | 0.27% |
| 10 | 7.34% | 0.06% | 59.12% | 3.22% | 0.28% |
| 11 | 7.23% | 0.02% | 56.95% | 3.44% | 0.30% |

In a fifteenth example, method 100 was performed on a fifteenth hemp oil. The fifteenth hemp oil is from method 200 and is the direct product of operation 218. The fifteenth hemp oil had a composition shown in Table 15 at time 0. This composition was heated to 95° C. and maintained within 95° C. (+/−2° C.) for 8 days. Pure oxygen was bubbled into the oil for the duration of the 8 days. Table 15 further shows the composition of the remediated hemp oil after the days indicated in the time column.

TABLE 15
[95 C. O2]

| Time (d) | % CBD | % THC | % CBG | % CBC | % CBN |
|---|---|---|---|---|---|
| 0 | 32.02% | 12.02% | 2.17% | 0.65% | 0.75% |
| 1 | 30.56% | 8.23% | 1.84% | 0.68% | 1.78% |
| 2 | 29.44% | 5.24% | 1.68% | 0.60% | 2.81% |
| 3 | 29.82% | 2.37% | 1.63% | 0.50% | 3.89% |
| 4 | 27.28% | 1.00% | 1.10% | 0.46% | 4.69% |
| 5 | 24.74% | 0.02% | 0.88% | 0.39% | 4.83% |
| 8 | 19.88% | 0.11% | 0.50% | 0.33% | 4.59% |

In a sixteenth example, method 100 was performed on a sixteenth hemp oil. The sixteenth hemp oil is from method 200 and is the direct product of operation 218. The sixteenth hemp oil had a composition shown in Table 16 at time 0. This composition was heated to 80° C. and maintained within 80° C. for 6 days. The vessel was pressurized with compressed air to a pressure of 95 psi, which was maintained for the duration of the 6 days. Table 16 further shows the composition of the remediated hemp after the days indicated in the time column.

TABLE 16
[80 C., 95 psi]

| Time (d) | % CBD | % THC | % CBG | % CBC | % CBN |
|---|---|---|---|---|---|
| 0 | 50.60% | 5.68% | 3.14% | 7.27% | 0% |
| 1 | 54.99% | 4.10% | 3.09% | 7.51% | 0.68% |
| 2 | 48.67% | 2.44% | 2.85% | 6.75% | 0.97% |
| 3 | 50.32% | 1.39% | 2.62% | 6.79% | 1.24% |
| 4 | 49.00% | 0.68% | 2.40% | 6.54% | 1.40% |
| 5 | 47.02% | 0.30% | 2.21% | 6.31% | 1.50% |
| 6 | 45.83% | 0.13% | 2.20% | 6.14% | 1.53% |

In a seventeenth example, method 100 was performed on a seventeenth hemp oil. The a seventeenth hemp oil is from method 200 and is the direct product of operation 218. The seventeenth hemp oil had a composition shown in Table 17 at time 0. This composition was heated to 100° C. and maintained at 100° C. (+/−2° C.) for 3 days. The vessel was pressurized with compressed air to a pressure of 95 psi (+/−5 psi), which was maintained for the duration of the 3 days. Table 17 further shows the composition of the remediated hemp oil after the days indicated in the time column.

TABLE 17
[100 C., 95 psi]

| Time (d) | % CBD | % THC | % CBG | % CBC | % CBN |
|---|---|---|---|---|---|
| 0 | 50.60% | 5.68% | 3.14% | 7.27% | 0% |
| 1 | 51.23% | 1.12% | 2.74% | 6.88% | 1.51% |
| 2 | 43.77% | 0.09% | 2.03% | 5.92% | 1.83% |
| 3 | 37.52% | 0.00% | 1.47% | 5.18% | 1.90% |

In an eighteenth example, method 100 was performed on a eighteenth hemp oil. The eighteenth hemp oil is from method 200 and is the direct product of operation 218. The eighteenth hemp oil had a composition shown in Table 18 at time 0. This composition was heated to 100° C. and maintained at 150° C. (+/−2° C.) for 6 hours. The vessel was pressurized with compressed air to a pressure of 95 psi (+/−5 psi), which was maintained for the duration of the 6 hours. Table 18 further shows the composition of the remediated hemp oil after the hours indicated in the time column. It is believed that THC would drop to under 0.3% in about 8 hours and undetectable in around 9 to 10 hours.

TABLE 18
[100 C., 95 psi]

| Time (d) | % CBD | % THC | % CBG | % CBC | % CBN |
|---|---|---|---|---|---|
| 0 | 54.00% | 5.70% | 3.16% | 7.54% | 0.22% |
| 1 | 53.62% | 4.64% | 3.12% | 7.36% | 0.34% |
| 2 | 53.47% | 3.45% | 2.96% | 7.25% | 0.61% |
| 3 | 50.13% | 1.67% | 2.64% | 6.73% | 1.89% |
| 6 | 45.91% | 0.87% | 2.41% | 6.02% | 2.55% |

In an nineteenth example, a nineteenth oil produced using method 100. The oil is distilled using operation 108. Table 19 shows the starting mass (in kg) and composition of the oil produced using method 100 in the row labeled input. The composition of the nineteenth oil is shown in the row labeled output.

TABLE 19
[Distillation of Remediated Mother Oil]

| | Mass (kg) | % CBD | % THC | % CBG | % CBC | % CBN |
|---|---|---|---|---|---|---|
| Input | 58.5 | 27.13% | 0.06% | 1.77% | 6.77% | 2.68% |
| Output | 38.4 | 32.64% | 0.02% | 1.92% | 9.03% | 2.99% |

One aspect of the technology is directed to a remediated hemp oil composition, comprising between about 2.9% and 74.95% Cannabidiol, between about 0% and 14.9% THC, between about 0.80% to 73% CBG, between about 0.5% and 51.01% CBC, and about 0.24% and 17.4% CBN.

### Selected Observations

Below is a non-exhaustive list of observations observed from using the technology described herein. The observations provided are not the only observations, and are provided as example observations. One skilled in the art may appreciate that other observations may be made.

At 150° C. (Table 1), the THC content is reduced by 9.3 in two days, while CBD maintains 77% of its original mass, CBG maintains 69% of its original mass, and CBC maintains only 27% of its original mass.

At 120 C (Table 4), the rate of THC degradation has slowed and maintenance of CBD and CBG levels are observed. The CBC levels dropped by over 50% at 7 days of run time. Over the same 7 day period, at a temperature of 100° C. (Table 6), a similar maintenance of CBD and CBG levels is observed, with CBC dropping by 17% of its original level. The same rate of THC degradation is observed at both 120 and 100° C.

Further lowering of the temperature to 90° C. (Table 7) shows THC levels of less than 0.3% are reached in 16 days. We see after 7 days that CBD, CBG, and CBC are maintained. By the end of the 16 day period, reduction of CBD, CBG, and CBC has been limited.

At 80° C. (Table 9), CBD, CBG, and CBC are well maintained; degradation of THC is very slow, marginally dropping over 8 days compared to some other examples.

When oxygen is used in place of air (Table 7), undetectable THC levels are reached in 7 days while CBD, CBG, and CBC levels are adequately maintained, having lost a few percentage points each by mass (2.5%, 2.4%, and 5% respectively).

An oxygen atmosphere achieves a two-fold increase in reaction rate while maintaining relatively high levels of CBD, CBG, and CBC.

Proceeding at 80° C. and increasing the pressure of the system to around 95 psi (using compressed air as the gas) (Table 17) allows THC degradation to less than 0.3% by mass while maintaining relatively high levels of CBD, CBG, and CBC compositions of the oil at 6 days.

At 95 psi with a temperature of 100 C (Table 18), the similar results as described above with referenced to table 17 can be achieved in 2 days. After two days, THC has been reduced over 63-fold while CBD has lost 6.83% by mass, CBG has lost 1.11% by mass and CBC has lost 1.35% by mass.

Observations on Crude Oils:

In crude oil extracted with solvent a more rapid decline in CBC levels is observed than with all other oils. The rate of THC degradation as well as CBD and CBG is consistent with all other oils tested. In crude oils extracted using CO2, this CBC degradation is not observed and THC degradation occurs more rapidly. It should be noted that the decarboxylation of crude oils can be performed concurrently with THC remediation in the same vessel without affecting the composition of the oil or time it takes to complete the process.

For certain applications a temperature between 90 and 100 C is found to be a useful balance of degradation rates between THC and other cannabinoids. The THC degradation rate is fast enough to be industrially applicable, while reducing the degradation of CBD, CBG, and CBC. A more oxygen rich atmosphere was found to maintain this balance while shortening the run times. Higher pressures are found shorten run time while maintaining THC degradation and keeping the other cannabinoids relatively high as a percentage of the oil.

This technology provides many advantages over current THC remediation methods as it is readily scalable, requires lower capital investment, has a higher throughput, provides CBN, and relatively preserves the CBD, CBG, and CBC content of the oils, and is amenable to nearly any type of hemp-derived oil.

The remediated oil can be removed of unwanted degradation products or additional plant matter through a distillation operation. Through the process the cannabinoids are enriched while maintaining compliant THC levels, producing a clear, golden oil that is more commercially viable because of the color and lack of odor.

### Example Method for Producing Starting Hemp Oil

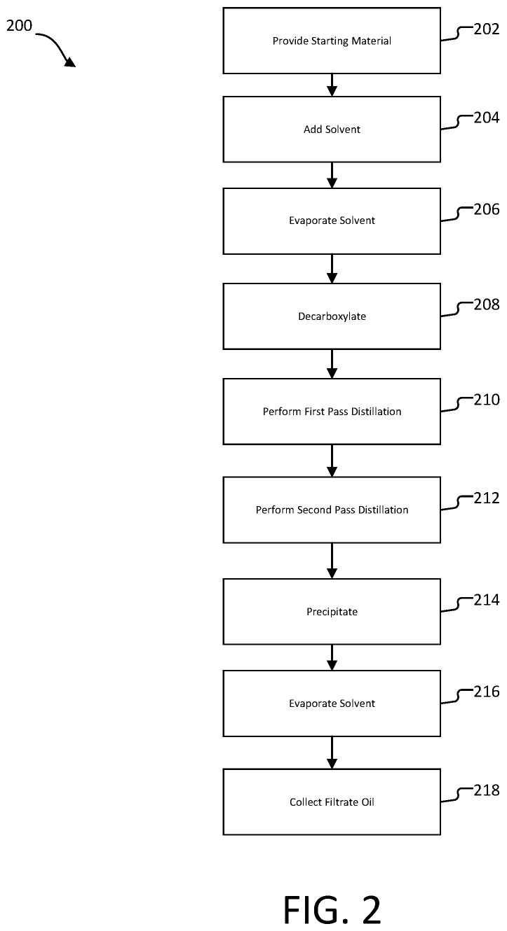

FIG. 2 illustrates a method 200 for producing a filtrate oil, which may be used as the starting hemp oil in method 100. Method 200 beings with a provide starting material operation 202. In one example, the starting material is hemp. Raw cannabis oil, in aspects of the technology, is derived from hemp using the LE Method, which is as follows. Cannabis flower from the hemp plant is transferred to a hammer mill where the flower is milled into a fine powder. This hammer milled raw cannabis powder is then transferred to the pellet mill where the hammer milled raw cannabis powder is compressed into approximately 2 cm×0.4 cm pellets. These raw cannabis pellets are then transferred to an extraction column.

An adding solvent operation 204 adds a solvent to the extraction column. In an example, the solvent is acetone (2.9:1 lbs of raw cannabis pellets:L of acetone). The raw cannabis pellets are soaked in acetone for 3 hours, and then the dark brown-green acetone/raw cannabis extract is pumped into a receiving container. Fresh acetone is pumped into the column containing raw cannabis pellets, and the soak process is repeated for another 3 hours. Then the acetone/raw cannabis extract is combined with the acetone/raw cannabis extract from the first extraction. Fresh acetone is pumped into the column containing raw cannabis pellets, and the soak process is repeated for another 3 hours. Then the acetone/raw cannabis extract is combined with the acetone/raw cannabis extract from the first and second extractions.

After this third soak process, the acetone/raw cannabis extract is concentrated in an evaporate solvent operation 206. In an example, the evaporate solvent operation 206 includes concentrating the extract under a vacuum at 50 degrees Celsius. The remaining raw cannabis oil is a viscous dark-brown green mixture.

Other methods of producing raw cannabis oil are known and may be used in conjunction with the technology described herein. For example CO₂ extraction methods and other methods are known. See, e.g., U.S. Pat. No. 8,895,078, Method for Producing and Extract from Cannabis Plant Matter, Containing a Tetrahydrocannabinol and a Cannabidiol and Cannabis Extracts to Mueller, filed Oct. 16, 2003; Chinese Patent Publication Number 105505565A, Method for Extracting Industrial Hemp Oil Rich in Cannabidiol to [symbol] (Tengchunjuan) et al., filed Dec. 28, 2015.

After producing raw oil, the raw oil is decarboxylated in a decarboxylate operation 208 to produce a decarboxylated oil. For the decarboxylate operation 208, the raw oil may be transferred to a reactor. The raw oil may be stirred at 120 degrees Celsius, for around two hours+/−30 minutes. In an example the raw oil is raw cannabis oil.

The decarboxylated oil is then subjected to two distillation passes. In a first pass distillation operation 210, the decarboxylated oil may be heated to around 140 degrees Celsius under vacuum at ˜1 torr. The first pass distillation produces a first pass distillate. In a second pass distillation operation 112, the first pass distillate may be heated to around 170 degrees Celsius under vacuum at 300-500 mtorr. The second pass distillation produces a second pass distillate. In an example the second pass distillate is a clear yellow-orange.

The second pass distillate is then subjected to a precipitation operation 214. In an example, precipitation may be done using heptane. In the precipitation operation 214, the collected second pass distillate may be placed in a reactor and stirred with heptane at 50 degrees Celsius for 30 minutes to dissolve the second pass distillate. The ratio of heptane to second pass distillate may be 1:1 (liters:kg). Once the second pass distillate is completely dissolved, the solution may be a clear yellow color. The solution may then be placed in a reactor and cooled to −6 degrees Celsius for at least 12 hours. A white-yellow precipitate may be observed in this second pass distillate/heptane mixture.

The second pass distillate/heptane mixture containing a precipitate is then subjected to an evaporate solvent operation 216. In an example, the evaporate solvent operation 216 comprises transferring the second pass distillate/heptane mixture containing the precipitate to a Buchner funnel. A precipitate mixture may then be recovered as a filter cake using vacuum filtration. In an example, the precipitate mixture may be a CBD precipitate mixture. The filtrate collected from the vacuum filtration may be an orange-yellow solution of heptane. The second pass distillate/heptane filtrate may then be concentrated under reduced pressure at 60 degrees Celsius to remove the heptane. The remaining filtrate oil may be an amber-orange oil. The filtrate oil is collected in a collect filtrate oil operation 218.

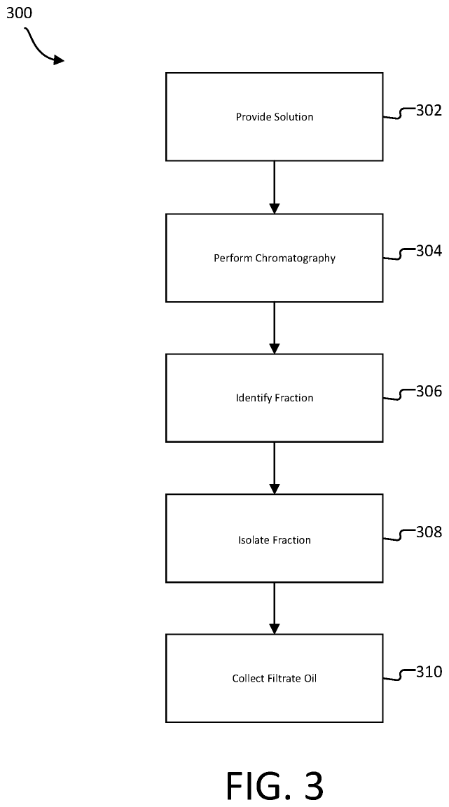

FIG. 3 is a method 300 for producing remediated hemp oil using chromatography. Method 300 begins with provide hemp oil operation 302. In provide hemp oil operation 302, a hemp oil is provided. In aspects of the technology, the hemp oil is one that contains detectable levels of THC. In an example the hemp oil is a decarboxylated oil, which may be produced using the decarboxylate operation 208 described above. In an alternative/additional examples the hemp oil is a first pass distillate produced from the perform first pass distillation operation 210. In additional/alternative examples the solution is a second pass distillate produced from the perform second pass distillation operation 212.

Method 300 then proceeds to perform chromatography operation 304. In operation 304, chromatography is performed on the hemp oil provided in operation 302. In aspects of the technology, chromatography will produce fractions with varying types/concentrations of cannabinoids. For example, the perform chromatography operation 304 may produce fractions that may be grouped into four fraction types: fractions containing mostly CBD, fractions containing high levels of THC, a minor cannabinoid-rich fraction having low levels of THC and low levels of CBD, and a fraction having low levels of all cannabinoids, include THC and CBD. Examples of chromatography methods are provided in U.S. patent application Ser. No. 16/376,855, filed Apr. 5, 2019, entitled “HEMP POWDER,” the written description, claims, and drawings of which is incorporated herein by reference in its entirety.

Method 300 then proceeds to pool relevant fraction operation 306. In operation 306, relevant fractions are pooled. These fractions may be pooled based on the amount of THC in the fraction. For example, the all fractions of a type that have detectable levels of THC (identified using thin-layer chromatography, for example) may be pooled together. Fractions are produced from the perform chromatography operation 304. These fractions may be subjected to the remediation method described in method 100, above.

### Example Method for Producing Starting Hemp Oil

FIG. 4 illustrates an example system 400 that may be used to perform aspects of the technology described herein, such as Method 100. It will be appreciated that the technology is not limited to the use of the example apparatus. As illustrated, apparatus 400 includes a vessel 402, an atmosphere 408, a gas bubbler 404 disposed within an oil 406, a heating element 408.

In aspects of the technology, the vessel 402 may be a vessel capable of holding pressure between 10 and 150 PSI. In other aspects, the vessel 402 may be a simple vessel capable of exposing the surface of the oil 406 to the atmosphere 408. In a specific example, the vessel 402 is one of a 20 mL borosilicate scint vial, a 100 mL round bottom flask, a 500 mL round bottom flask, a 1000 mL Erlenmeyer flask, a 5 L jacketed glass reactor, a 10 L jacketed glass reactor, 20 L jacketed glass reactor, a 100 L jacketed stainless steel reactor, 400 L jacketed stainless steel reactor, a 1 L jacketed stainless steel pressure vessel, a 100 L jacketed stainless steel reactor, a 400 L jacketed stainless steel reactor 20 ml L jacketed stainless steel pressure vessel, a 100 L jacketed stainless steel reactor, and a 400 L jacketed stainless steel reactor.

The oil 406 may be any starting oil described herein, such as the oils described above.

A heating element 408 may heat the oil 406. As illustrated, the heating element 408 is in direct contact with the oil 406, though it need not be. In some examples, the vessel 402 is heated, thus heating the oil 406 indirectly. In other examples, the gas dispersed into the oil 406 through the bubbler 404 may be heated, thus heating the oil. In such an example, the heating element may be located in stream of the gas supply. The bubbler 404 may be a perforated pipe.

The atmosphere 408 may be pressurized. For example, the vessel 408 may be pressure controlled, with a pressure release valve and or pressure regulator (not shown) to keep the pressure of the tank at or around an elevated pressure, such as 75 PSI, 80 PSI, 85 PSI, 90 PSI, 100 PSI, 105 PSI, 110 PSI, and so on. The pressure may be controlled by controlling the rate at which gas is bubbled through bubbler 404 and/or a pressure regulator/valve (not shown).

What is claimed is:

1. A method of producing remediated oil, comprising:
providing a starting material;
adding a solvent to the starting material;
evaporating the solvent in a vacuum to produce a raw oil;
decarboxylating the raw oil to produce a decarboxylated oil;
performing a first pass distillation on the decarboxylated oil by heating the decarboxylated oil to produce a first pass distillate;
performing a second pass distillation on the first pass distillate by heating the first pass distillate to produce a second pass distillate;
precipitating the second pass distillate to produce a precipitate and filtrate;
evaporating solvent from the filtrate to produce a filtrate oil; and
heating and agitating the filtrate oil simultaneously to produce a remediated filtrate oil.

2. The method of claim 1, wherein agitating the filtrate oil comprises bubbling a gas through the filtrate oil.

3. The method of claim 1, wherein the starting material is hemp.

4. A method of producing remediated hemp oil, comprising:
providing a tetrahydrocannabinol containing hemp oil, wherein the tetrahydrocannabinol hemp oil comprises a detectable level of tetrahydrocannabinol;
heating the tetrahydrocannabinol hemp oil; and
during the heating the tetrahydrocannabinol hemp oil operation, bubbling air through the tetrahydrocannabinol hemp oil to produce a remediated hemp oil.

5. The method of claim 4, wherein the tetrahydrocannabinol hemp oil is formed by:
providing a starting hemp oil;
performing chromatography on the starting hemp oil; identifying at least one fraction from the chromatography; and
combining the at least one fraction to form the tetrahydrocannabinol oil.

6. The method of claim 5, wherein the identifying step is thin layer chromatography and the at least one fraction identified contains tetrahydrocannabinol.

7. The method of claim 4, wherein during at least a portion of the heating the tetrahydrocannabinol hemp oil operation, tetrahydrocannabinol to cannabinol conversion occurs at a rate of at least one selected from the group consisting of: 0.37, 0.41, 0.53, 0.62, 0.84, or 1.02 wt. % per day.

8. A remediated hemp oil composition, comprising:
about 28.69 to about 36.30 wt. % cannabidiol;
not more than 0.3 wt. % tetrahydrocannabinol;
about 2.42 to about 5.98 wt. % cannabigerol;
about 9.11 to about 18.09 wt. % cannabichromene;
about 3.78 to about 6.79 wt. % Cannabinol; and
about 0.50 to about 1.66 wt. % cannabidivarin.

9. The remediated hemp oil composition of claim 8, wherein the total Cannabinoids is about 52.60 to 61.98 wt. %.

10. The remediated hemp oil composition of claim 8, comprising not more than 29.50 wt. % Cannabidiol.

11. The remediated hemp oil of composition claim 8, comprising about 28.69 wt. % cannabidiol.

12. The remediated hemp oil composition of claim 8, comprising not more than 0.2 wt. % tetrahydrocannabinol.

13. A method of producing remediated oil, comprising:
providing a starting oil containing THC, CBD, CBC, and CBG;
heating and agitating the starting oil simultaneously to produce a remediated oil, wherein the remediated oil is characterized by having less THC than the starting oil.

14. The method of claim 13, further comprising:
exposing the starting oil to an atmosphere, wherein the atmosphere is selected from the group consisting of: air and a gas comprising around 99% oxygen.

15. The method of claim 14, wherein the pressure during the heating and agitating operation is held at around 95 PSI.

16. The method of claim 15, wherein the THC of the remediated oil has been lowered by at least 5% by mass without dropping CBC levels by more than 2% by mass.

17. The method of claim 16, wherein the heating and agitation occurs no longer than two days.

18. The method of claim 13, further comprising distilling the remediated oil to produce a clear, orange oil.

19. The method of claim 13, wherein the starting oil is a second pass distillation.

20. The method of claim 13, further comprising:
exposing the remediated oil to air at the surface of the oil;
wherein the surface area to volume of the oil is less than 1.26.
